(19) United States
(12) Patent Application Publication
(10) Pub. No.: US 2014/0338507 A1
(43) Pub. Date: Nov. 20, 2014

(54) FOOD PEELER AND METHOD OF USING SAME

(71) Applicants: Robert E. Whewell, JR., Charlotte, NC (US); Susan Anastasia Rose Whewell, Charlotte, NC (US)

(72) Inventors: Robert E. Whewell, JR., Charlotte, NC (US); Susan Anastasia Rose Whewell, Charlotte, NC (US)

(21) Appl. No.: 14/279,627

(22) Filed: May 16, 2014

Related U.S. Application Data
(60) Provisional application No. 61/824,421, filed on May 17, 2013.

(51) Int. Cl. A47J 17/04

(52) U.S. Cl. CPC A47J 17/04
USPC 83/13; 30/279.2

(57) ABSTRACT

A food peeling device includes a housing for gripping by a user having an opening shaped and sized to receive a food item, such as the base end of a banana. At least one cutting member is contained within the housing, and has an edge for piercing the base end of the banana. The housing can have a frusto-conical shape.

### CROSS-REFERENCES TO RELATED APPLICATIONS

This application claims priority to U.S. Provisional Application No. 61/824,421, filed May 17, 2013, which is incorporated herein by reference.

### TECHNICAL FIELD AND BACKGROUND OF THE INVENTION

The present invention relates to an apparatus for peeling items such as food. One embodiment of the invention comprises a food peeler particularly suited for peeling bananas.

Bananas are a healthy and nutritious food, containing many major vitamin groups. They are a staple food in many tropical populations.

When eating bananas, it is common for the consumer to grasp the stem (commonly considered the top of the banana) with one hand and with the other hand attempt to peel off the outer skin of the banana from the top down to expose the inner flesh of the banana to be eaten. When peeling a banana in this manner, unwanted string-like pieces of the banana known as phloem remain attached to the banana flesh. Most consumers do not wish to eat these phloem pieces. Furthermore, they are unwanted and present a nuisance when using bananas as an ingredient for cooked or baked dishes.

If a banana is peeled from the end opposite to the stem, typically considered the base end, the phloem sticks to the outer skin as the skin is peeled from the banana flesh, and the phloem is removed from the flesh along with the skin, resulting in generally phloem free flesh for consumption. However, it is often difficult, if not for a consumer to open and successfully peel a banana from the base without substantially damaging the flesh of the banana. Accordingly, there is a need for an apparatus to facilitate the peeling of bananas from the base.

### SUMMARY OF INVENTION

Therefore, one object of the present invention is to provide an apparatus that can be used to peel food items, such as bananas. Another object of the invention is to provide a method of peeling a banana from its base. These and other objects of the invention can be obtained in the preferred embodiments of the invention described below.

One embodiment of the invention comprises an apparatus for peeling a food item comprising a housing adapted for gripping by a user having at least one opening adapted for receiving an end of the food item, and at least one cutting member contained within the housing and adapted for piercing the food item.

According to another embodiment of the invention, the cutting member can be a panel attached to the inner surface of the housing. The panel has an edge for piercing the food item.

According to another embodiment of the invention, the edge of the panel is concave in relation to the at least one opening in the housing.

According to another embodiment of the invention, the housing is substantially frusto-conical, and has a first circular end and a second circular end opposed to the first end. The first end has a larger diameter than the second end.

According to another embodiment of the invention, the first circular end is shaped and sized to receive an end of a food item, such as the base end of a banana.

According to another embodiment of the invention, the panel extends across a center axis of the housing, such that the panel divides the housing into two substantially symmetrical sections.

According to another embodiment of the invention, the panel has a second edge opposed to the first edge. The first edge is positioned proximate the first end of the housing and the second edge is proximate the second end of the housing.

According to another embodiment of the invention, the panel increases in thickness from the first edge to the second edge, such that the first edge is thinner than the second edge.

According to another embodiment of the invention, the peeler is shaped and sized to peel bananas.

According to another embodiment of the invention, the housing has a substantial dome shape.

According to another embodiment of the invention, first and second elongate segments are attached to the inner surface of the housing in a crisscross orientation.

According to another embodiment of the invention, a banana peeler apparatus comprises a housing adapted for gripping by a user having at least one opening adapted for receiving a base end of a banana. At least one cutting member is contained within the housing, and has a first edge for piercing the base end of the banana.

According to another embodiment of the invention, a method of peeling a banana comprises providing a banana and a peeler apparatus comprising a housing adapted for gripping by a user having an opening adapted for receiving the base end of a banana, and at least one cutting member contained within the housing having an edge for piercing the base end of the banana. The base end of the banana is positioned against the edge of the cutting member, and the cutting member edge is urged against the base end of the banana to pierce the outer skin of the banana proximate the base end. The pierced outer skin can be pulled away from the banana flesh, exposing banana flesh that is substantially free of phloem.

### BRIEF DESCRIPTION OF THE DRAWINGS

FIG. 1 is a perspective view of a food peeler according to a preferred embodiment of the invention;

FIG. 2 is a top plan view of the food peeler of FIG. 1;

FIG. 3 is a bottom plan view of the food peeler of FIG. 1;

FIG. 4 is an environmental view illustrating a method of using the food peeler of FIG. 1 according to a preferred embodiment of the invention;

FIG. 5 is another environmental view illustrating a method of using the food peeler of FIG. 1 according to a preferred embodiment of the invention;

FIG. 6 is a perspective view of a banana after being peeled in accordance with methods of the invention;

FIG. 7 is a perspective view of a food peeler according to another preferred embodiment of the invention;

FIG. 8 is another perspective view of the food peeler of FIG. 7;

FIG. 9 is a top plan view of the food peeler of FIG. 7;

FIG. 10 is a bottom plan view of the food peeler of FIG. 7;

FIG. 11 is another perspective view of the food peeler of FIG. 7;

FIG. 12 is another perspective view of the food peeler of FIG. 7;

FIG. 13 is a side view of the food peeler of FIG. 7;

FIG. 14 is an environmental view illustrating a method of using the food peeler of FIG. 7 according to a preferred embodiment of the invention;

FIG. 15 is another environmental view illustrating a method of using the food peeler of FIG. 7 according to a preferred embodiment of the invention; and

FIG. 16 is another environmental view illustrating a method of using the food peeler of FIG. 7 according to a preferred embodiment of the invention.

### DESCRIPTION OF PREFERRED EMBODIMENTS OF THE INVENTION AND BEST MODE

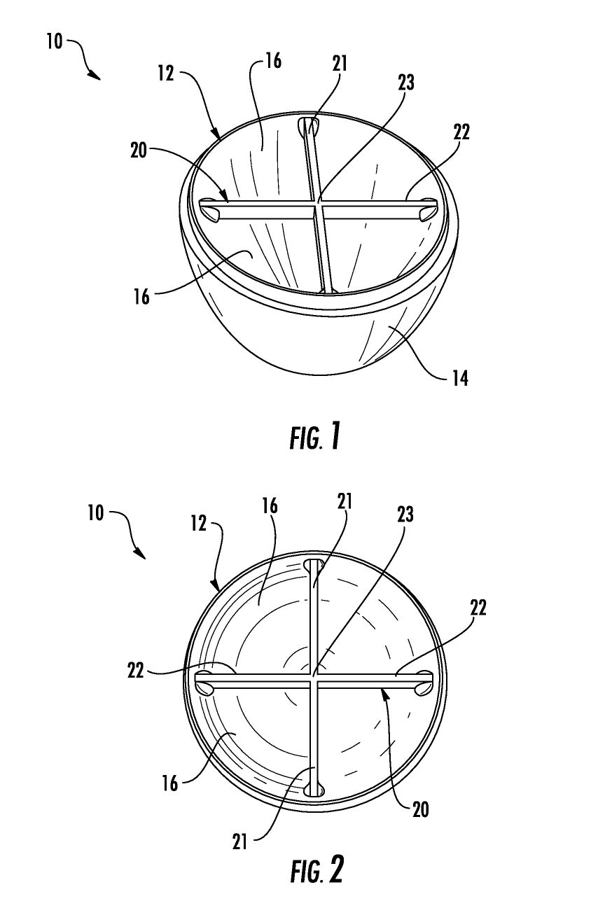

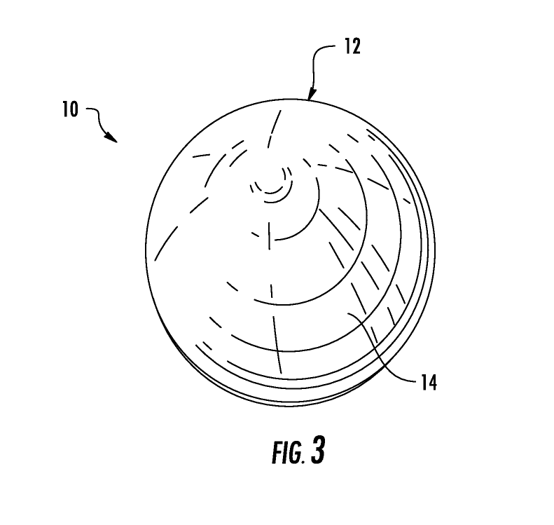

A food peeler according to a preferred embodiment of the invention is illustrated in FIGS. 1-3, and shown generally at reference numeral 10. The peeler 10 comprises an outer housing 12, and an inner section 20 positioned within the housing 12. As shown in FIGS. 1 and 3, the outer housing 12 can be a dome shaped structure with an exterior surface 14 and an interior surface 16. The outer housing 12 is open at one end to expose the inner section, as shown in FIGS. 1 and 2. The outer housing 12 is shown as being dome shaped in this particular embodiment 10 of the invention, it should be noted that the outer housing 12 can be of varying shapes.

The inner section 20 can be comprised of two cutting members, such as substantially flat elongate segments 21, 22 attached to the inner surface 16 of the housing 12. As shown in FIGS. 1 and 2, the segments 21, 22 can be positioned in a crisscross arrangement, in which the segments 21, 22 are substantially perpendicular to each other and intersect each other at the approximate center of the housing 12 forming a center point 23. The outer housing 12, and inner section 20 can be made of plastic, metal or other suitable material. The segments 21, 22 of the inner section 20 are sufficiently thin to form an edge that can pierce the outer skin of a banana.

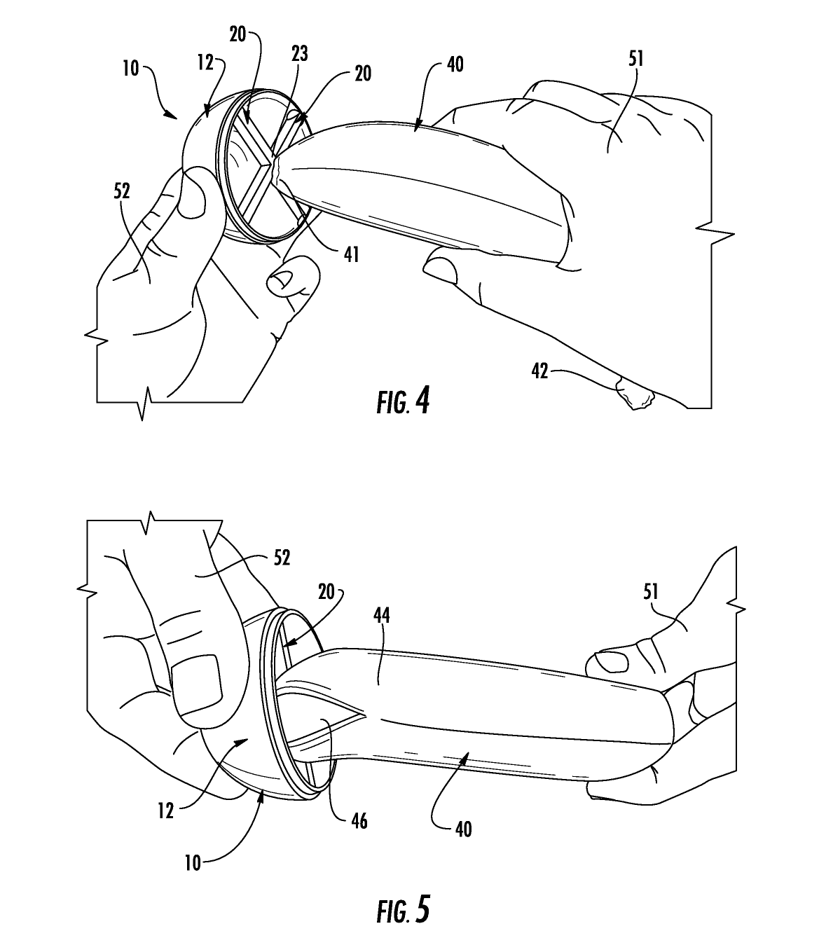

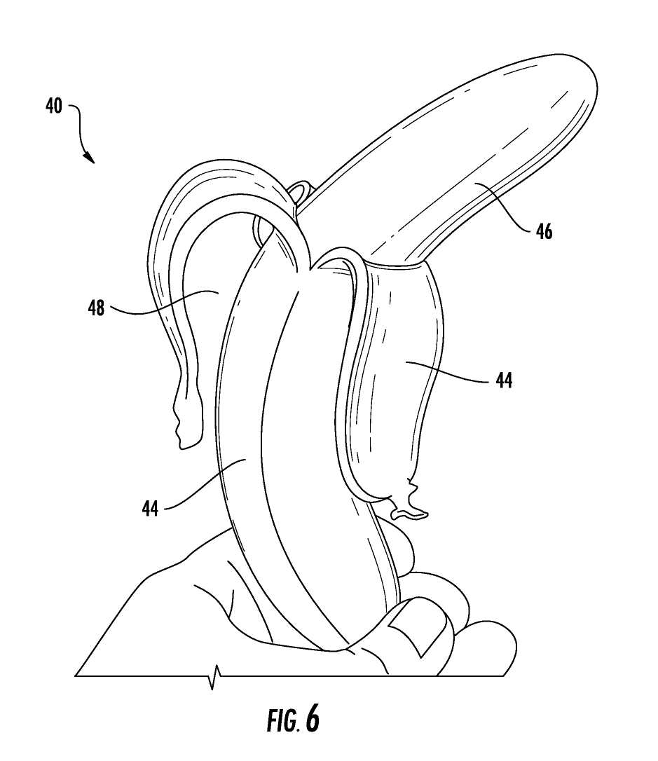

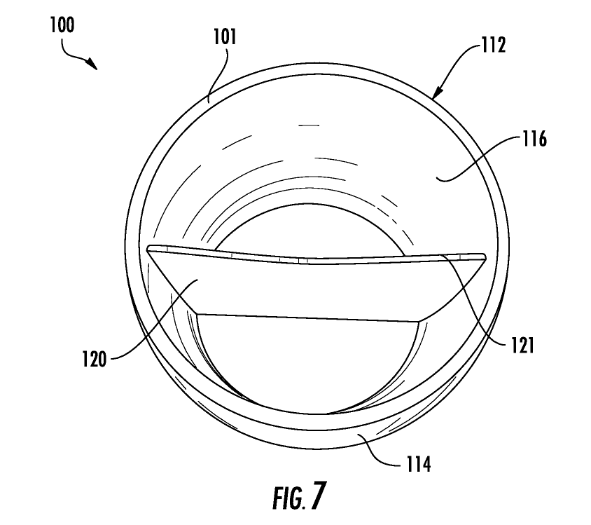

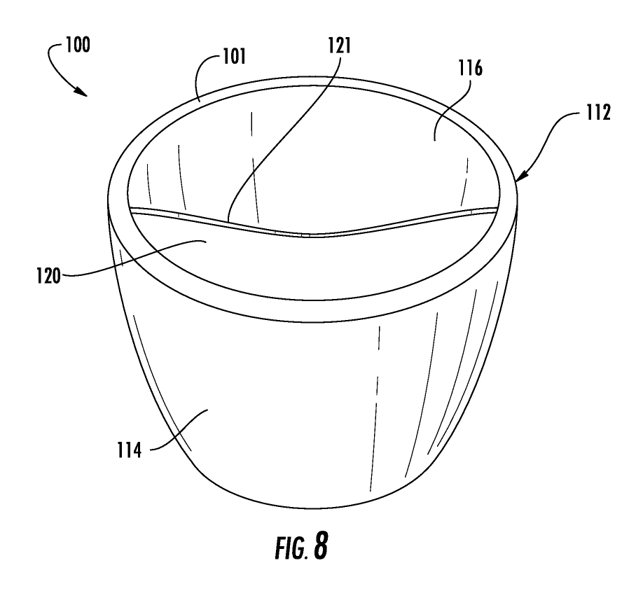

FIGS. 4-6 illustrate a method according to a preferred embodiment of the invention, in which the peeler 10 is used to peel a banana 40. The banana 40 is held in one hand 51 of the user, and the user holds the outer housing 12 of the peeler 10 in the other hand 52, as shown in FIG. 4. The base end 41 of the banana 40 (the end opposite the stem 42) is positioned against the center point 23 of the inner section 20 of the peeler 10. The user forces the inner section 20 of the peeler 10 against the base 41 of the banana 40, piercing the outer skin 44 of the banana, as shown in FIG. 5. The outer skin 44 of the banana 40 is thereby opened and can be easily peeled back from the banana flesh 46. As the user peels the outer skin 44 from the base 41 of the banana 40, the phloem 48 sticks to the skin 44 and is removed from the banana flesh 46 along with the skin 44, resulting in a banana 40 with exposed banana flesh 44 free of phloem, as shown in FIG. 6.

It should be noted that while the peeler 10 is described above for use in a method of peeling bananas, the peeler 10 is not so limited and can be used to pierce and/or peel other food items.

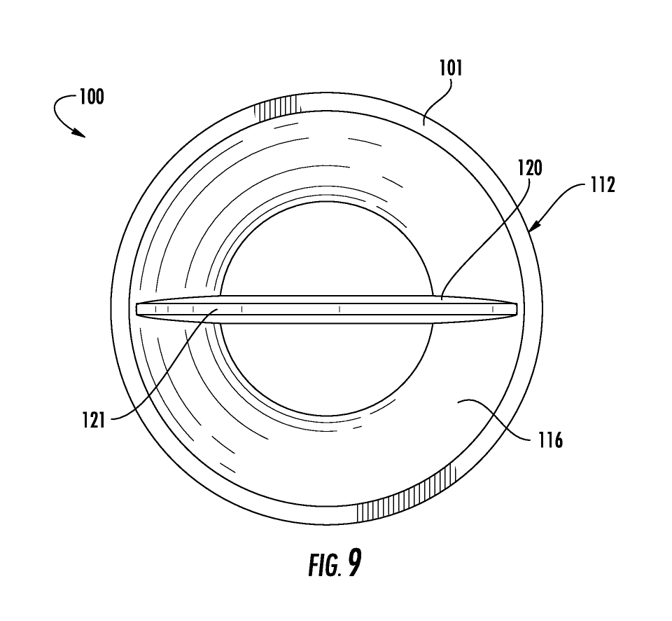

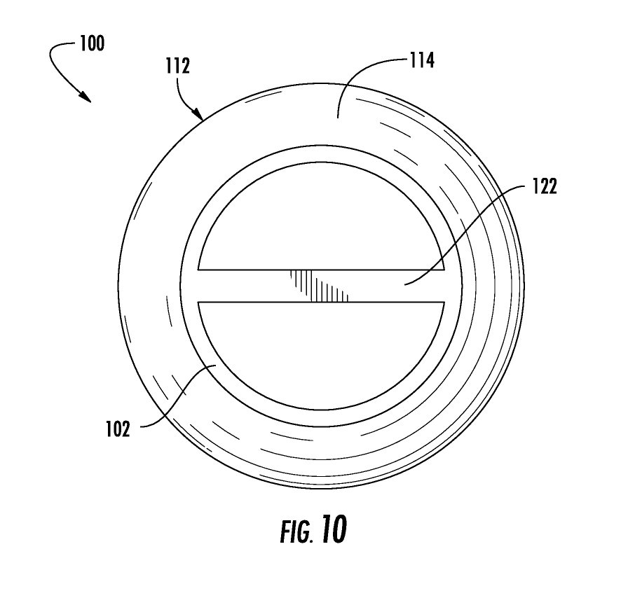

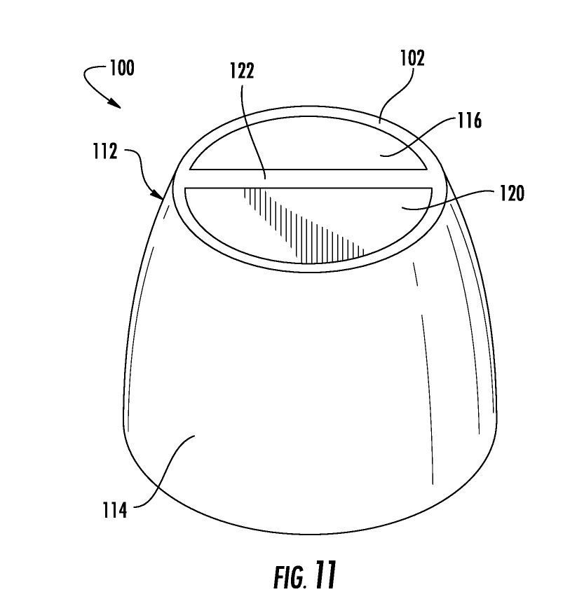

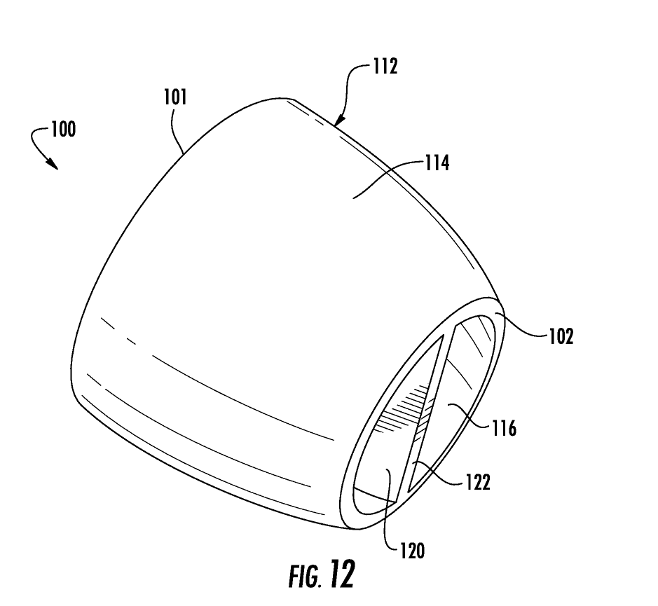

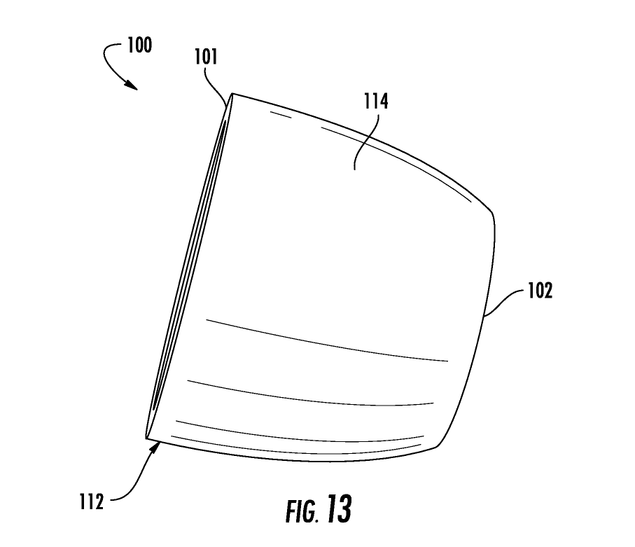

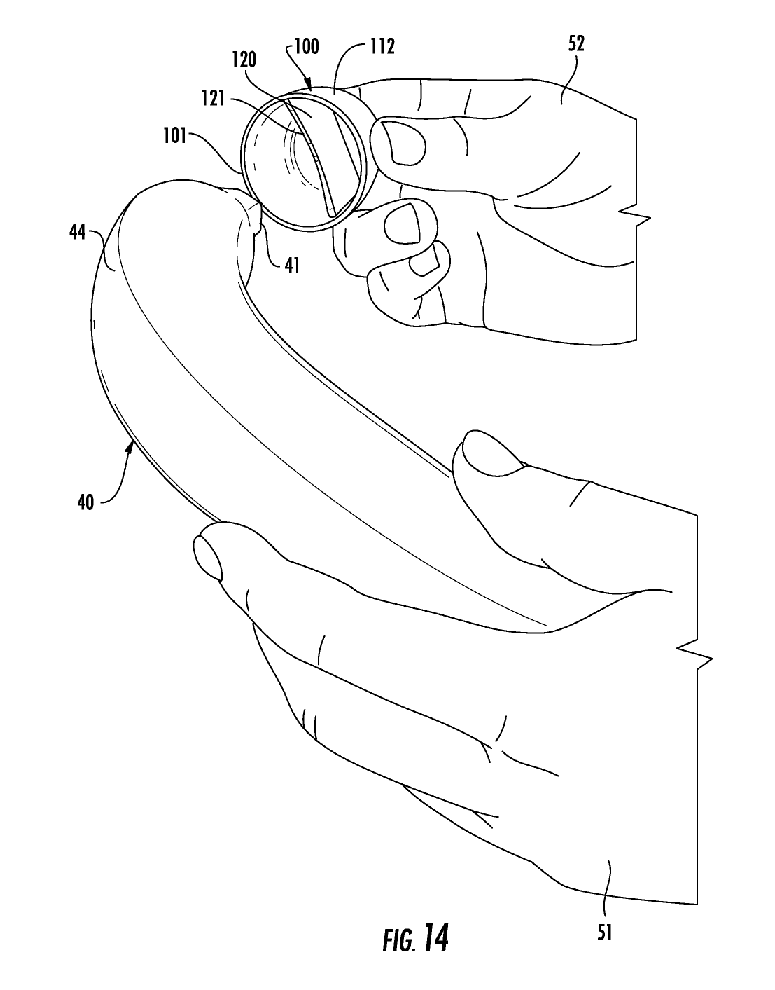

A food peeler according to another preferred embodiment of the invention is illustrated in FIGS. 7-16, and shown generally at reference numeral 100. The peeler 100 comprises an outer housing 112, and an inner cutting member 120 positioned within the housing 112. The outer housing 112 has an exterior surface 114 and an interior surface 116, and a substantially frusto-conical shape, as shown in FIGS. 7-13. The outer housing 112 is open at both a first circular end 101, shown in FIG. 9, and a second circular end 102 opposite the first end, shown in FIG. 10. The first end 101 defines an opening having a larger diameter than the second end 102, as shown in FIGS. 9 and 10. The first end 101 opening exposes the inner section 120, as shown in FIGS. 7 and 9. While the outer housing 112 is shown as being substantially frusto-conical in this particular embodiment 100 of the invention, the outer housing 112 can be of varying shapes, such as the dome shape shown in the previously described embodiment 10.

The inner cutting member 120 can be a single panel attached to the inner surface 116 of the housing 112. The housing 112 and the panel 120 can be integrally formed together, such as by plastic injection molding. Alternatively, the panel 120 can be a separate piece that is attached to the housing 120 by adhesive, or other suitable attachment means. The outer housing 112, and inner panel 120 can be made of plastic, metal or other suitable material.

As shown in FIGS. 7 and 9, panel 120 section extends across the interior of the housing 120 along an center axis of the housing 112, such that the panel 120 divides the housing 112 into two substantially symmetrical sections, as shown in FIG. 9. The inner panel 120 has a first edge 121, shown in FIGS. 7-9, that is proximate to the first end 101 of the housing 112, and a second edge 122, opposed to the first edge 121 that is proximate the second end 102 of the housing 112, as shown in FIGS. 10-12. The panel 120 increases in thickness from the first edge 121 to the second edge 122, such that the first edge 121 is thinner than the second edge 122. The first edge 121 is sufficiently thin and sharp so as to be able to pierce the outer skin of a banana. The graduated thickness of the panel 120 provides added strength and facilitates piercing the banana skin.

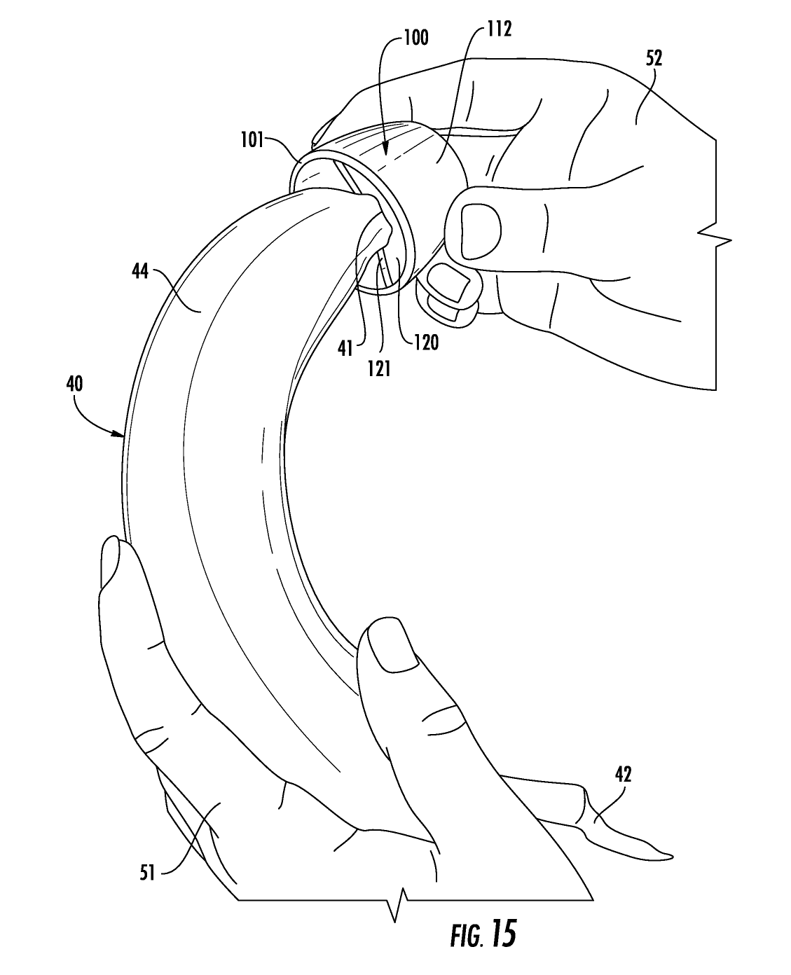

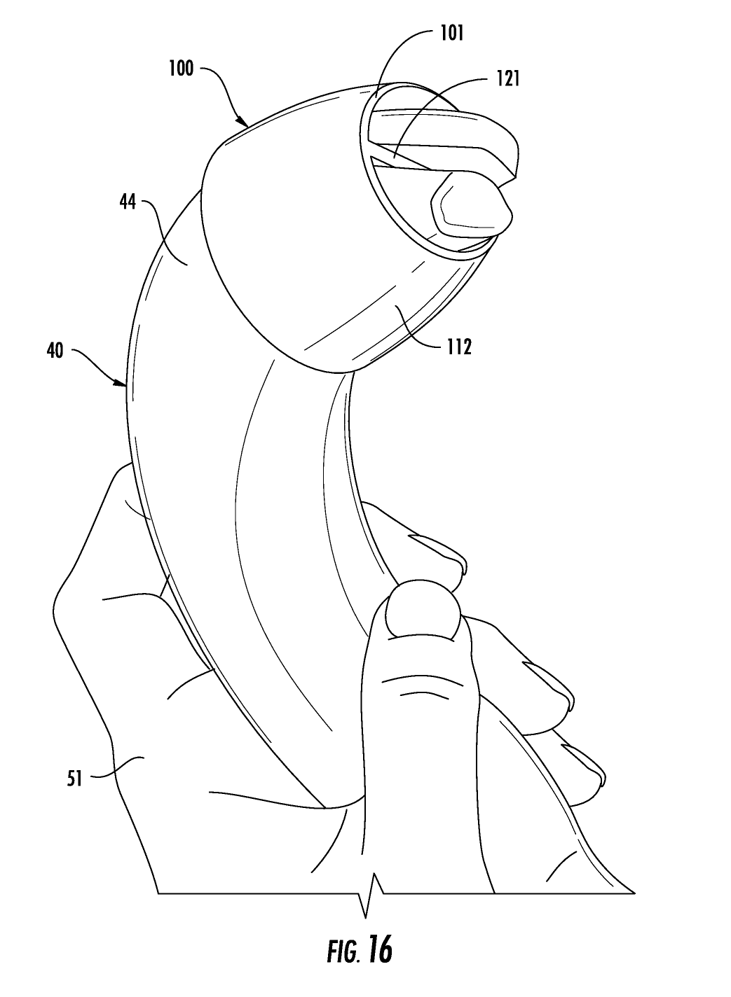

FIGS. 14-16 illustrate a method according to a preferred embodiment of the invention, in which the peeler 100 can be used to peel a banana 40. The banana 40 is held in one hand 51 of the user, and the user holds the outer housing 112 of the peeler 100 in the other hand 52, as shown in FIG. 14. The base end 41 of the banana 40 (the end opposite the stem 42) is positioned against the first edge 121 of the inner cutting member 120 of the peeler 100, as shown in FIG. 15. The user forces the inner cutting member 120 of the peeler 100 against the base 41 of the banana 40, piercing the outer skin 44 of the banana, as shown in FIG. 16. The outer skin 44 of the banana 40 is thereby opened and can be easily peeled back from the banana flesh 46. As the user peels the outer skin 44 from the base 41 of the banana 40, the phloem 48 sticks to the skin 44 and is removed from the banana flesh 46 along with the skin 44, resulting in a banana 40 with exposed banana flesh 44 free of phloem, as shown in FIG. 6.

It should be noted that while the peeler 100 is described above for use in a method of peeling bananas, the peeler 100 is not so limited and can be used to pierce and/or peel other food items.

A food peeler and a method of using same are described above. Various changes can be made to the invention without departing from its scope. The above description of various embodiments and the best mode of the invention are provided for the purpose of illustration only and not limitation—the invention being defined by the claims and equivalents thereof.

What is claimed is:

1. An apparatus for peeling a food item comprising:
(a) a housing adapted for gripping by a user, and having at least one opening adapted for receiving an end of the food item; and
(b) at least one cutting member attached to the housing and adapted for piercing the food item.

2. The apparatus according to claim 1, wherein the at least one cutting member comprises a panel section attached to an inner surface of the housing and having a first edge for piercing the food item.

3. The apparatus according to claim 2, wherein the first edge is concave in relation to the at least one opening in the housing.

4. The apparatus according to claim 3, wherein the housing is substantially frusto-conical, and comprises a first circular end and a second circular end opposed to the first end, the first end having a larger diameter than the second end.

5. The apparatus according to claim 4, wherein the first circular end defines the at least one opening adapted for receiving an end of the food item.

6. The apparatus according to claim 5, wherein the panel section extends across a center axis of the housing, whereby the panel section divides the housing into two substantially symmetrical sections.

7. The apparatus according to claim 5, wherein the panel section comprises a second edge opposed to the first edge, the first edge positioned proximate the first end of the housing and the second edge proximate the second end of the housing.

8. The apparatus according to claim 7, wherein the panel section increases in thickness from the first edge to the second edge, whereby the first edge is thinner than the second edge.

9. The apparatus according to claim 1, wherein the food item comprises a banana.

10. The apparatus according to claim 1, wherein the housing has a substantial dome shape.

11. The apparatus according to claim 1, wherein the at least one cutting member comprises first and second elongate segments attached to an inner surface of the housing, the first and second segments positioned in a crisscross orientation.

12. The apparatus according to claim 11, wherein the housing has a substantial dome shape.

13. A banana peeler apparatus comprising:
(a) a housing adapted for gripping by a user, and having at least one opening adapted for receiving a base end of a banana; and
(b) at least one cutting member contained within the housing and having a first edge for piercing the base end of the banana.

14. The apparatus according to claim 13, wherein the at least one cutting member comprises a panel attached to an inner surface of the housing.

15. The apparatus according to claim 13, wherein the first edge is concave in relation to the at least one opening in the housing.

16. The apparatus according to claim 13, wherein the housing is substantially frusto-conical, and comprises a first circular end and a second circular end opposed to the first end, the first end having a larger diameter than the second end, and defining the at least one opening adapted for receiving an end of the food item.

17. The apparatus according to claim 16, wherein the panel section extends across a center axis of the housing, whereby the panel section divides the housing into two substantially symmetrical sections.

18. The apparatus according to claim 16, wherein the panel section comprises a second edge opposed to the first edge, the first edge positioned proximate the first end of the housing and the second edge proximate the second end of the housing, and further wherein the panel section increases in thickness from the first edge to the second edge, whereby the first edge is thinner than the second edge.

19. A method of peeling a banana comprising the steps of:
(a) providing a banana having a flesh, an outer skin covering the flesh, a stem end and a base end opposite the stem end;
(b) providing a peeler apparatus comprising:
(i) a housing adapted for gripping by a user, and having an opening adapted for receiving the base end of a banana; and
(ii) at least one cutting member contained within the housing and having an edge for piercing the base end of the banana;
(c) positioning the base end of the banana against the edge of the cutting member;
(d) forcing the cutting member edge against the base end of the banana to pierce the outer skin of the banana proximate the base end; and
(e) gripping the outer skin of the banana proximate the base end and pulling the outer skin away from the banana flesh.

20. The method according to claim 19, wherein the housing is substantially frusto-conical, and the cutting member comprises a panel attached to an inner surface of the housing.
